(19) United States
(12) Patent Application Publication
(10) Pub. No.: US 2004/0185321 A1
(43) Pub. Date: Sep. 23, 2004

(54) SOFC WITH FLOATING CURRENT COLLECTORS

(76) Inventors: David Sutherland, Calgary (CA); Vlad Kalika, Calgary (CA); Scott Sherman, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/708,186

(22) Filed: Feb. 13, 2004

Related U.S. Application Data
(60) Provisional application No. 60/319,949, filed on Feb. 14, 2003.

(51) Int. Cl. H01M 2/08; H01M 8/12

(52) U.S. Cl. 429/35; 429/32; 429/37

(57) ABSTRACT

A solid oxide fuel cell stack having a compression plate and a terminal fuel cell includes a current collector plate comprising a substantially solid planar element disposed immediately adjacent the compression plate; an gas-impermeable interconnect plate disposed immediately adjacent and in electrical contact with the terminal fuel cell; and a compressible electrically conductive element in electrical contact with the interconnect plate and the current collector plate.

### CROSS REFERENCE TO RELATED APPLICATIONS

The present invention claims the priority of U.S. Provisional Patent Application No. 60/319,949 filed on Feb. 14, 2003, the contents of which are incorporated herein by reference.

### BACKGROUND OF INVENTION

The present invention relates to a solid oxide fuel cell stack having floating current collectors.

Conventional solid oxide fuel cell stacks are formed from stacked interconnect plates, also known as bipolar plates, fuel cells comprising membranes and electrodes, and seals. The interconnects and the fuel cells are typically planar and define air and fuel intake and exhaust openings. When stacked vertically, the openings define the intake and exhaust manifolds. The interconnect plates have internal passages on either side of a central barrier which directs air or fuel from its intake manifold, across the fuel cell electrode and into the exhaust manifold. Typically, the fuel cell is square and in a cross-flow cell, the fuel gas flows in a direction perpendicular to the direction of air flow across the cell.

The interconnect is conventionally made from a machined metal plate. More recently, interconnects have been fashioned from three plates laminated together by gluing or brazing. Although a laminated interconnect is easier and cheaper to fabricate than a machined plate, it is still a laborious and time-consuming process.

In a conventional fuel cell stack, at least three gasket seals are required on either side of an interconnect: one for each set of manifolds and one to surround the electrode surface of the fuel cell. More typically, five gasket seals are required: one for each manifold and one for the fuel cell. The seals pose a significant hurdle for efficient fuel cell operation as they must provide adequate gas seals while being somewhat compressible, flexible and tolerant of heat cycling within the fuel cell stack. More importantly, in a fuel cell stack with metallic or electrically conductive interconnects, the seals must be dielectric to prevent electrically shorting the fuel cell stack.

The fuel cells are typically combined in series and a cathode current collector is provided at one end of the stack and an anode current collector is provided at the other end of the stack. The current collector in either case is typically a solid metal plate which contacts the terminal interconnect which in turn contacts the electrode of the terminal fuel cell and may include manifold passages, if the stack is internally manifolded, as well as a tab for connecting a current conductor cable.

As shown in U.S. Pat. No. 5,856,035, the current collector is conventionally directly attached to the interconnect plate, which serves as a current conductor.

A fuel cell stack must be carefully compressed to ensure the seals between the interconnects and the fuel cells function properly and the appropriate electrical contact is made, without cracking the ceramic fuel cells, which are typically quite brittle. As a result, the interface between the current collectors and the terminal fuel cell is important. The terminal fuel cell has a tendency to crack when the stack is compressed due to uneven pressure points exerted by the terminal interconnect due to its inherent rigidity. This is particularly true at the cathode end of the fuel cell stack as the cathode may directly contact portions of the terminal interconnect.

Therefore, there is a need in the art for a fuel cell stack with current collectors which may mitigate the difficulties of the prior art.

### SUMMARY OF INVENTION

The present invention relates to a planar solid oxide fuel cell stack comprising a floating current collector. As used herein, a current collector is said to float if it does not directly contact the interconnect to which it is immediately adjacent.

Therefore, in one embodiment, the invention comprises a planar solid oxide fuel cell stack comprising a lower horizontal compression plate, an upper compression plate, a plurality of interleaved fuel cells, seals and interconnects, a cathode current collector plate and an anode current collector plate disposed between the upper and lower compression plates, wherein the stack defines vertical fuel intake and exhaust manifolds and vertical air intake and exhaust manifolds, said stack comprising:(a)a seal element having a cell opening;(b)a compressible, conducting element disposed within the cell opening of the seal element; (c)wherein the seal element and the compressible element are disposed between the cathode current collector plate and a terminal interconnect at the cathode end of the stack or between the anode current collector plate and a terminal interconnect at the anode end of the stack, or both.

The compressible element preferably comprises a conformable metal foam, which is more preferably a nickel foam. Additionally, the seal element may define a fuel passage from the fuel intake manifold to the fuel exhaust manifold such that fuel may pass through or around the compressible element.

In a preferred embodiment, the terminal interconnect comprises flow-directing ribs in contact with an electrode surface and the conducting element. The compressible element conforms to the ribs.

### BRIEF DESCRIPTION OF DRAWINGS

The invention will now be described by way of an exemplary embodiment with reference to the accompanying simplified, diagrammatic, not-to-scale drawings. In the drawings:

FIG. 1 is an exploded view of a fuel cell unit.

FIG. 2A is a top view of one embodiment of an interconnect showing a seal-defined cathode flow field. FIG. 2B shows the underside of the interconnect shown in FIG. 2A, showing a seal-defined anode flow field.

FIG. 3A shows one embodiment of a interconnect plate.

FIG. 3B shows one embodiment of a cell holder plate matching the interconnect.

FIG. 4 is an expanded view of one embodiment of the present invention.

### DETAILED DESCRIPTION

The present invention provides for a fuel cell stack with floating current collectors. A fuel cell stack of the present invention consists of a repeating series of fuel cells, seals and interconnects wherein the interconnects and seals define fuel and air chambers on each side of each fuel cell, isolating each of the fuel and air delivery and exhaust systems. As used herein, “vertical” or “vertically” shall refer to a direction normal to the planar elements of the fuel cell stack. Accordingly, “horizontal” or “horizontally” shall refer to a direction parallel to the planar elements. When describing the present invention, all terms not defined herein have their common art-recognized meanings.

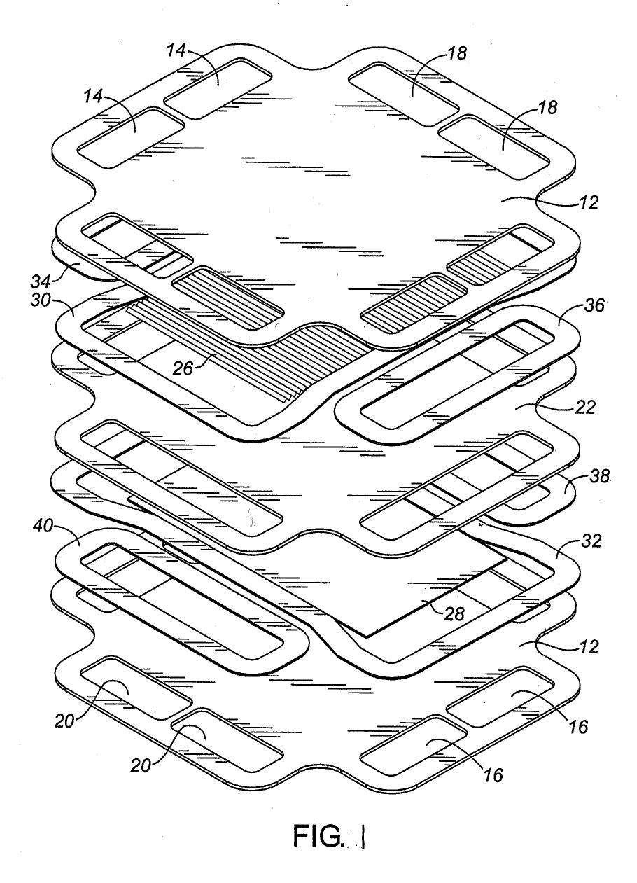

FIG. 1 illustrates a basic embodiment of a fuel cell unit. A fuel cell stack comprises a plurality of these units stacked vertically. Each unit comprises an interconnect (12) having an upper anode surface and a lower cathode surface and defining a fuel intake manifold (14), a fuel exhaust manifold (16), an air intake manifold (18) and an air exhaust manifold (20). In the embodiment shown, the anode and cathode surfaces are square areas while the manifolds are openings disposed around the central electrode area. Below the interconnect is a planar fuel cell element (22) having a cathode surface and an anode surface. In one embodiment, the fuel cell element has the same shape as the interconnect, to allow for vertical alignment, and is internally manifolded, defining a fuel intake manifold (14), a fuel exhaust manifold (16), an air intake manifold (18) and an air exhaust manifold (20). In an alternative embodiment, the fuel cell element may be framed by a fuel cell holder plate (24), in which case the fuel cell element and the holder plate fit together to form a planar element. The manifolds of the fuel cell (22) or the fuel cell holder plate (24) each align vertically with the corresponding manifold in the interconnect (12).

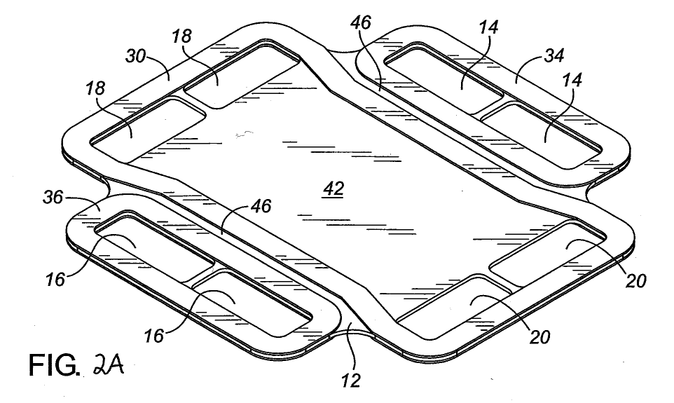

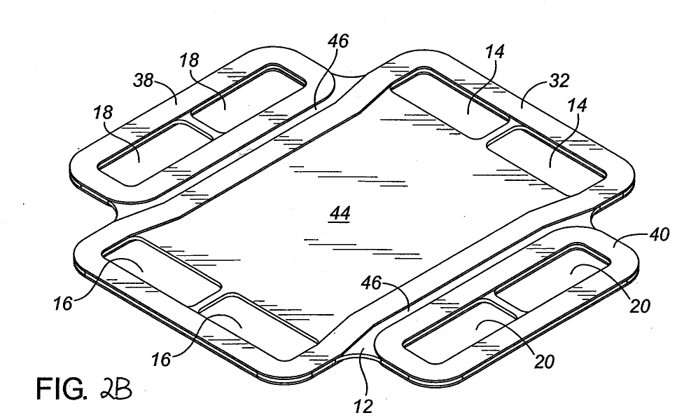

Reactant flow in the manifolds and across opposing sides of the fuel cell is directed by seals as may be seen in FIG. 1 and in FIGS. 2A and 2B . On the cathode side of the fuel cell (22), a cathode gasket seal (30) surrounds the air intake and exhaust manifolds (18, 20) and the cathode-facing surface (42) of the interconnect (12), while excluding the fuel intake and exhaust manifolds (14, 16). Each of the fuel intake and exhaust manifolds (14, 16) is surrounded by separate seals (34, 36). On the anode side of the fuel cell, an anode gasket seal (32) surrounds the fuel intake and exhaust manifolds (14, 16) and the anode surface (44) of the fuel cell, while excluding the air intake and exhaust manifolds (16, 18). Accordingly, the vertical manifolds formed in the stack by the aligned manifold openings (14, 16, 18, 20) feed reactants to the appropriate side of the fuel cell through a flow field bounded horizontally by a gasket seal (30 or 32) and vertically by the fuel cell electrode (42 or 44) and the interconnect (12).

Air or oxidant flow is depicted in FIG. 1 by arrows (A). Fuel flow is depicted in FIG. 1 by arrows (F).

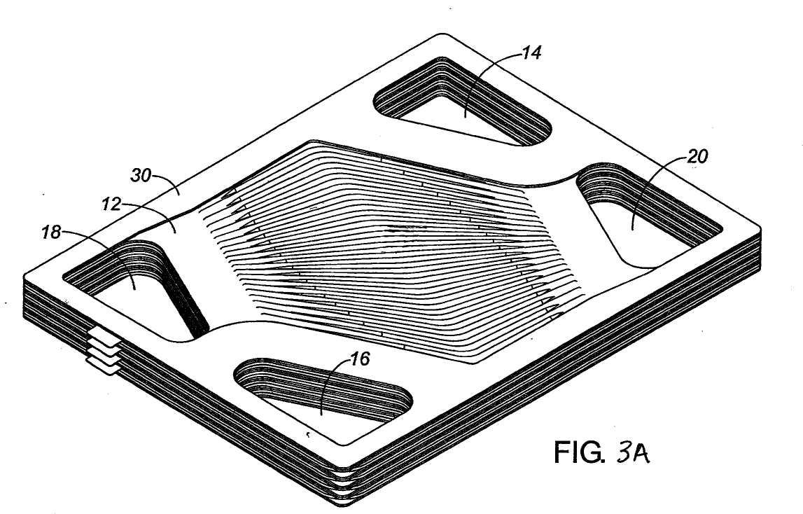

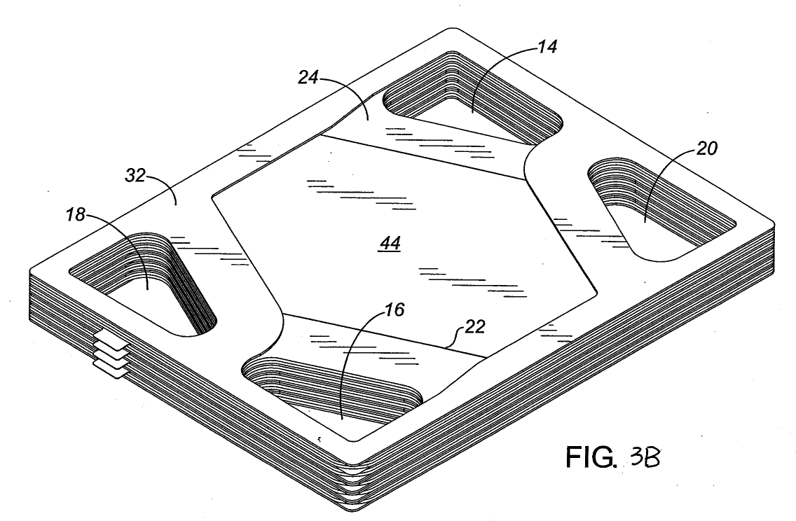

In one embodiment, the cell (22) may be hexagonal in shape and mate with a cell holder plate (24) which defines the manifolds. The interconnect (12) may therefore be configured as shown in FIGS. 3A and 3B and a cell holder plate (24) may be configured as shown in FIG. 3B. The cell (22) fits within the central opening of the cell holder plate (24) and forms a planar unit with the cell holder plate (24). Gasket seals (30, 32) between the interconnect and the cell holder plate direct gas flow diagonally from an intake manifold to an exhaust manifold. FIG. 3A shows the cathode side (50) of the interconnect (12) and therefore, the flow field created by the cathode gasket seal (30) includes the air intake manifold (18) and the air exhaust manifold (20).

On the opposite side of the cell holder plate and cell, the anode gasket seal (32) creates an anode (44) flow field including the fuel intake and exhaust manifolds (14, 16) while sealing the air intake and exhaust manifolds (18, 20).

In one embodiment, as shown in FIGS. 3A and 3B, a single seal element may be formed which combines the separate seals shown in FIG. 1. Cathode seals (30, 34, 36) may be combined into a single seal, while anode seals (32, 38, 40) may be combined into a single seal. In this case, each of the cathode and anode gasket seals (30, 32) seals the peripheral edge of the interconnect and defines three openings. A central flow field opening serves to define the reactant flow field across the fuel cell electrode, while the remaining two openings serve to define and exclude the opposing intake and exhaust manifolds.

In one embodiment, the interconnects (12) serve as current collectors and therefore must be in electrical contact with the fuel cell electrodes. Therefore, a first porous electrically conducting contact material (26) is disposed between the cathode surface and the cathode surface of the interconnect as shown in FIG. 6 while a second porous contact material (28) is disposed between the anode surface and the upper surface of a lower interconnect. Obviously, the lower interconnect is the upper interconnect (12) of the fuel cell unit immediately below and adjacent to the unit described herein.

In one embodiment, both the cathode contact material (26) and the anode contact material (28) may comprise any porous, electrically conducting material which is chemically compatible with the fuel cell and oxidizing gases or reducing atmospheres. In one embodiment, the material comprises an expanded metal or nickel foam or their equivalent. A suitable expanded metal may include an expanded stainless steel. Suitable nickel foam may include nickel having between about 50 pores per inch to about 90 pores per inch. Suitable nickel foam is commercially available and may have a density between about 500 g/m² and 1500 g/m² of material ranging in thickness 1.3 to about 1.7 mm thick. The contact material may be slightly thicker than the flow field and therefore will be compressed slightly upon assembly of the fuel cell stack.

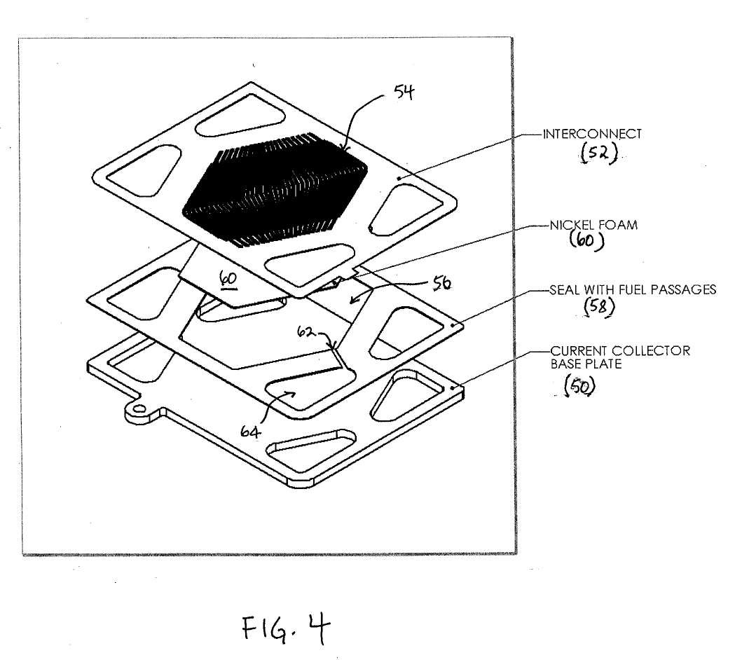

As seen in FIG. 4, a fuel cell stack includes a bottom compression plate (not shown) adjacent the cathode current collector (50). The terminal fuel cell (not shown) is orientated cathode side down with the cathode in contact with the terminal interconnect (52). The fuel cell stack may be assembled as described above or in co-pending U.S. patent application Ser. No. 10/707,229 filed on Nov. 28, 2003 and entitled “Flow Field Equalization Pathways”, the contents of which are incorporated herein by reference. The cathode current collector (10) is said to “float” as it does not directly contact the terminal interconnect.

In one embodiment, the terminal interconnect (52) has ribs (54) embossed into the plate such that the raised ribs contact the cathode surface of the fuel cell. The embossed area coincides with the fuel cell and with the cell opening (56) of the seal (58). A compressible, conductive element (60) is shaped to fit within the cell opening of the seal (58) and provides electrical contact between the terminal interconnect (52) and the current collector (50). The compressibility of the element (60) distributes the compressive force applied through the current collector (50) against the interconnect (52) and the terminal fuel cell. In one embodiment, the compressible element is about 1.7 mm thick while the seal (58) is about 0.7 mm thick (before compression). Therefore, upon installation in the stack, the compressible element (60) will be compressed to less than half its original thickness and will conform to the reverse side of the embossed ribs (54).

In one embodiment, the compressible element (20) may be the same as the electrode contact materials described above and comprise a porous metal foam. The foam is preferably a nickel foam. Nickel is a preferred element as it is readily available in sheets of highly porous foam, is a good electrical conductor and is chemically compatible with a SOFC. Other conducting and compressible materials may be determined to be suitable by those skilled in the art with minimal experimentation. Such materials may include electrically conductive ceramic or metal felts, expanded metal, or metal pastes compatible with the SOFC environment.If nickel is used in the compressible element, those skilled in the art will recognize that nickel may oxidize at the elevated operating temperature of the fuel cell stack, as may other non-precious metals. Accordingly, in one embodiment, provision is made to provide a reducing atmosphere surrounding the compressible element. One embodiment, as shown in FIG. 4, includes the use of a small passage (62) cut into the seal to provide gas communication between the fuel intake manifold (64), through the cell opening (56) and to the fuel exhaust manifold (66). A small of amount of fuel then passes through the nickel foam (60) to maintain it in its reduced metallic state. In one embodiment, the width of the fuel passage is less than about 5 mm and may be about 3 mm wide. The amount of fuel that is diverted is nominal but is sufficient to prevent oxidation of the nickel. The amount of fuel that is diverted will decrease as the width or height of the fuel passage decreases or as the porosity of the compressible element (20) decreases. In either case, the pressure drop from the fuel intake manifold to the compressible element enclosure will increase. In alternative embodiments, the diverted fuel may be reused in the stack in some manner rather than being simply exhausted through the fuel exhaust manifold.

In an alternative embodiment, the anode current collector (not shown) may also be configured to float in the same manner as the cathode current collector described above. On the anode side, the terminal fuel cell abuts against the terminal interconnect with the anode side up. The terminal interconnect is oriented such that the reverse side of the embossed ribs contacts the anode surface. In between the terminal interconnect and the anode current collector, a seal has a cell opening which fits a compressible, conductive element in a similar manner as that described above. The compressible element will then conform to the ribs of the terminal interconnect and provide electrical contact with the anode current collector plate. As will be appreciated by those skilled in the art, a fuel leakage path may still be used if the compressible element is comprised of nickel or another oxidizable metal to maintain a reducing atmosphere around the compressible element.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A planar solid oxide fuel cell stack comprising a lower horizontal compression plate, an upper compression plate, a plurality of interleaved fuel cells, seals and interconnects, a cathode current collector plate and an anode current collector plate disposed between the upper and lower compression plates, wherein the stack defines vertical fuel intake and exhaust manifolds and vertical air intake and exhaust manifolds, said stack comprising:
(a) a seal element having a cell opening;
(b) a compressible, conducting element disposed within the cell opening of the seal element;
(c) wherein the seal element and the compressible element are disposed between the cathode current collector plate and a terminal interconnect at the cathode end of the stack or between the anode current collector plate and a terminal interconnect at the anode end of the stack, or both.

2. The fuel cell stack of claim 1 wherein the compressible element comprises a metal foam.

3. The fuel cell stack of claim 2 wherein the compressible element comprises a nickel foam.

4. The fuel cell stack of claim 1 wherein the seal element defines a small fuel passage from the fuel intake manifold to the fuel exhaust manifold such that fuel may pass through or around the compressible element.

5. The fuel cell stack of claim 1 wherein the interconnect comprises flow-directing ribs in contact with an electrode surface and the conducting element.

6. A planar solid oxide fuel cell stack having a compression plate and a terminal fuel cell, said fuel cell stack comprising:
(a) a current collector plate comprising a substantially planar element disposed immediately adjacent the compression plate;
(b) an interconnect plate disposed immediately adjacent and in electrical contact with the terminal fuel cell;
(c) a compressible layer comprising a compressible electrically conductive element in electrical contact with the interconnect plate and the current collector plate.

7. The fuel cell stack of claim 6 wherein the compressible layer further comprises a seal element surrounding the compressible element.

8. The fuel cell stack of claim 7 wherein the compressible element comprises an oxidizable material, and the seal element defines a fuel passage for diverting fuel from a fuel intake manifold, through or around the compressible element, and into a fuel exhaust manifold.

9. The fuel cell stack of claim 8 wherein the compressible element comprises nickel foam.
